(19) United States
(12) Patent Application Publication
(10) Pub. No.: US 2010/0247259 A1
(43) Pub. Date: Sep. 30, 2010

(54) DRILL BIT

(76) Inventors: Rick Davidian, Waxhaw, NC (US); Thomas Evatt, Six Mile, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/411,550

(22) Filed: Mar. 26, 2009

(51) Int. Cl. B23B 51/00

(52) U.S. Cl. 408/228

(57) ABSTRACT

A drill bit includes a shaft having a first end portion connectable to a power tool and a second end portion substantially opposite the first end portion. The shaft defines a longitudinal axis extending through the first and second end portions. The drill bit also includes a first generally planar blade coupled to the second end portion of the shaft and defining a first cutting edge extending generally perpendicularly from the axis, a second generally planar blade coupled to the second end portion of the shaft and defining a second cutting edge extending generally perpendicularly from the axis, a third blade coupled to the second end portion of the shaft and defining a third cutting edge extending generally perpendicularly from the axis, and a pilot tip extending from at least one of the first, second, and third cutting edges generally along the longitudinal axis.

### BACKGROUND

The present invention relates to drill bits.

Drill bits, such as spade bits, typically include two generally planar blades to cut a hole in a work piece. The blades, or cutters, are commonly supported on a shaft that is connectable to a rotary power tool, such as a drill. As the power tool rotates the drill bit, the blades bore a hole through a work piece. However, the blades tend to splinter the work piece when they emerge from an opposite side of the work piece, creating a rough and unclean hole in the work piece.

### SUMMARY

In one embodiment, the invention provides a drill bit including a shaft having a first end portion connectable to a power tool and a second end portion substantially opposite the first end portion. The shaft defines a longitudinal axis extending through the first and second end portions. The drill bit also includes a first generally planar blade coupled to the second end portion of the shaft and defining a first cutting edge extending generally perpendicularly from the longitudinal axis, and a second generally planar blade coupled to the second end portion of the shaft and defining a second cutting edge extending generally perpendicularly from the longitudinal axis. The second blade is spaced apart from the first blade about the longitudinal axis. The drill bit further includes a third blade coupled to the second end portion of the shaft and defining a third cutting edge extending generally perpendicularly from the longitudinal axis. The third blade is spaced apart from the first blade and the second blade about the longitudinal axis. The drill bit also includes a pilot tip extending from at least one of the first, second, and third cutting edges generally along the longitudinal axis.

In another embodiment, the invention provides a drill bit including a shaft having a first end portion connectable to a power tool and a second end portion opposite the first end portion. The shaft defines a longitudinal axis extending through the first and second end portions. The drill bit also includes a first generally planar blade coupled to the second end portion of the shaft and defining a first cutting edge extending radially from the longitudinal axis, and a second generally planar blade coupled to the second end portion of the shaft and defining a second cutting edge extending radially from the longitudinal axis. The second blade is spaced apart from the first blade about the longitudinal axis. The drill bit further includes a third blade coupled to the second end portion of the shaft and defining a third cutting edge extending radially from the longitudinal axis. The third blade is spaced apart from the first blade and the second blade about the longitudinal axis. The drill bit also includes a cutting spur coupled to an end of the third blade substantially opposite the longitudinal axis. The cutting spur extends axially from the third cutting edge.

In yet another embodiment, the invention provides a drill bit including a shaft having a first end portion connectable to a power tool and a second end portion substantially opposite the first end portion. The shaft defines a longitudinal axis extending through the first and second end portions. The drill bit also includes a first generally planar blade coupled to the second end portion of the shaft and defining a first cutting edge extending generally perpendicularly from the longitudinal axis, and a second generally planar blade coupled to the second end portion of the shaft and defining a second cutting edge extending generally perpendicularly from the longitudinal axis. The second blade is spaced apart from the first blade by approximately 180° about the longitudinal axis. The drill bit further includes a third blade coupled to the second end portion of the shaft and defining a third cutting edge extending generally perpendicularly from the longitudinal axis. The third blade is spaced apart from the first blade and the second blade about the longitudinal axis. The drill bit also includes a fourth blade coupled to the second end portion of the shaft and defining a fourth cutting edge extending generally perpendicularly from the longitudinal axis. The fourth blade is spaced apart from the third blade by approximately 180° about the longitudinal axis. The drill bit further includes a pilot tip extending from the third blade and the fourth blade generally along the longitudinal axis.

Other aspects of the invention will become apparent by consideration of the detailed description and accompanying drawings.

### BRIEF DESCRIPTION OF THE DRAWINGS

FIG. 1 is a perspective view of a drill bit embodying the invention.

FIG. 2 is an enlarged perspective view of a portion of the drill bit shown in FIG. 1.

FIG. 3 is a side view of the portion of the drill bit shown in FIG. 2.

FIG. 4 is an end view of the drill bit shown in FIG. 1.

FIG. 5 is a perspective view of another embodiment of a drill bit.

FIG. 6 is an enlarged perspective view of a portion of the drill bit shown in FIG. 5.

FIG. 7 is a side view of the portion of the drill bit shown in FIG. 6.

FIG. 8 is an end view of the drill bit shown in FIG. 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting.

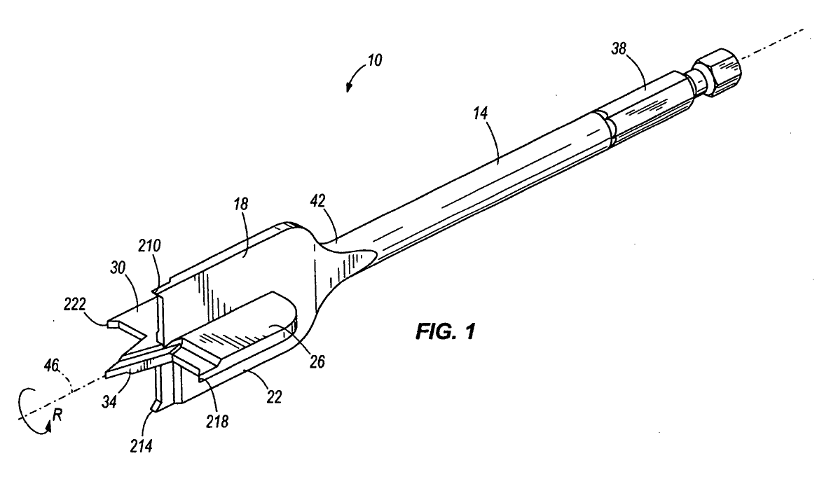

FIGS. 1-4 illustrate a drill bit 10 according to one embodiment of the invention. The drill bit 10 is connectable to a rotary power tool, such as, for example, a drill, to cut one or more holes in a work piece. The illustrated drill bit 10 includes an elongated shaft 14 to connect to the power tool, a plurality of blades 18, 22, 26, 30 to cut a hole in a work piece, and a cutting tip 34 to facilitate proper alignment of the drill bit 10 with the work piece.

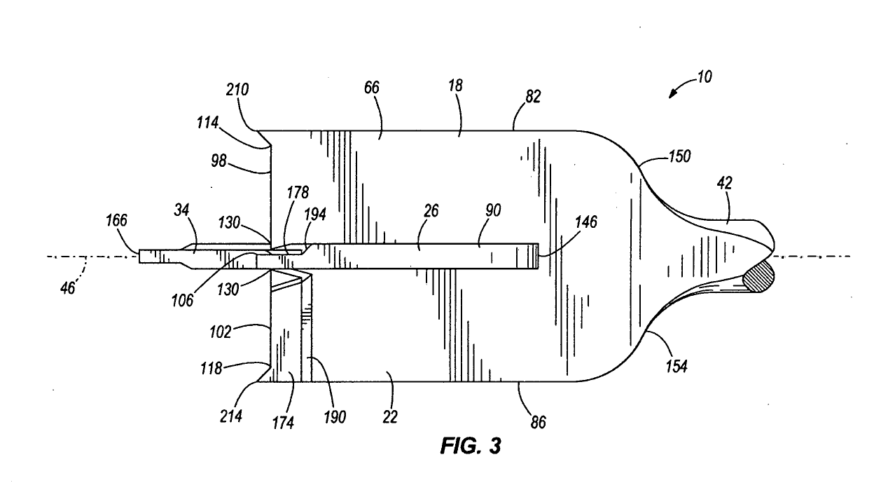

As shown in FIG. 1, the shaft 14 includes a first end portion 38 that is connectable to a power tool and a second end portion 42 positioned substantially opposite from the first end portion 38. The first end portion 38 has a generally hexagonal cross-section and is insertable into a chuck of a power tool. The chuck engages and clamps the first end portion 38 to secure the drill bit 10 to the power tool such that the drill bit 10 is rotated by the chuck. The second end portion 42 supports the plurality of blades 18-30. The shaft 14 also defines a longitudinal axis 46 (FIGS. 1 and 3) extending through the first and second end portions 38, 42. The shaft 14 and the blades 18-30 rotate in a direction R about the longitudinal axis 46 when the drill bit 10 is rotated by the power tool.

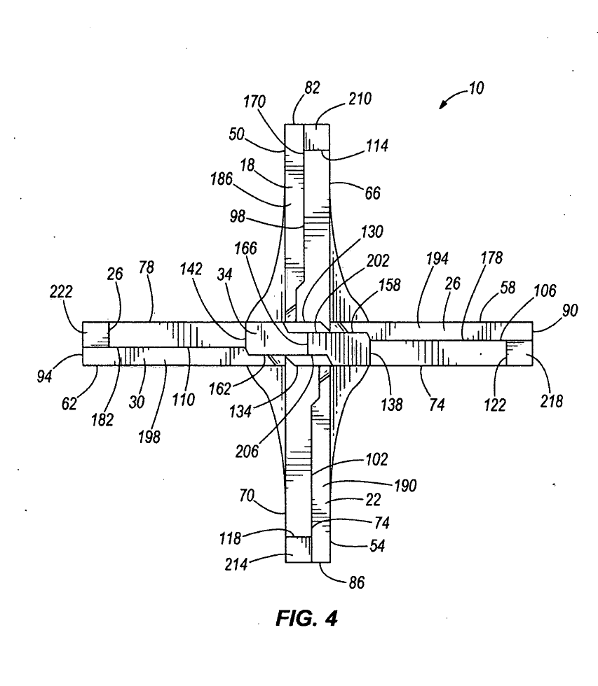

In the illustrated construction, the drill bit 10 includes four blades 18-30 coupled to the second end portion 42 of the shaft 14. In other constructions, the drill bit 10 may include fewer or more blades 18-30 (e.g., three blades, five blades, six blades, etc.). As shown in FIG. 4, the illustrated blades 18-30 are equally or symmetrically spaced apart about the longitudinal axis 46. That is, the blades 18-30 are circumferentially spaced apart from one another by approximately 90° such that the first and second blades 18, 22 are spaced approximately 180° apart about the axis 46 and the third and fourth blades 26, 30 are spaced approximately 180° apart about the axis 46. In other constructions, the blades 18-30 may be unequally spaced apart from one another about the longitudinal axis 46. For example, the first and second blades 18, 22 may be spaced approximately 180° apart about the axis 46 and the third and fourth blades 26, 30 may be spaced approximately 180° apart about the axis 46, but the third blade 26 may be spaced apart from the first and second blades 18, 22 at an angle other than 90°. In still other constructions, the blades 18-30 may be spaced apart from one another by different angles such that the blades 18-30 are asymmetrically positioned about the axis 46.

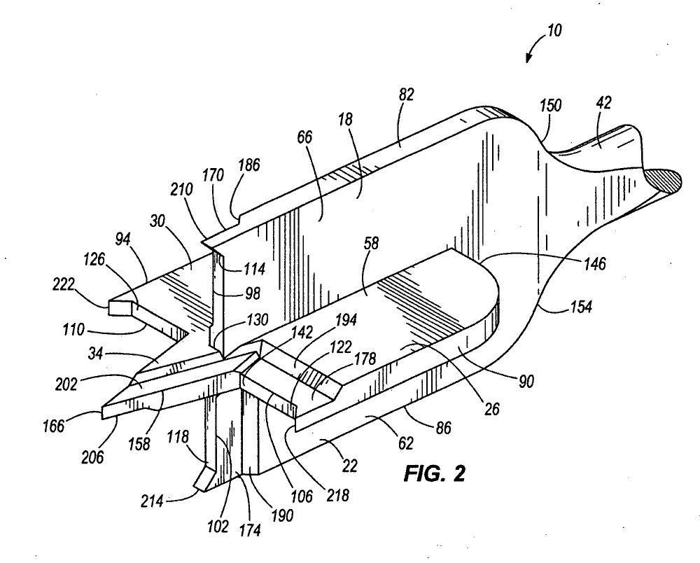

As shown in FIGS. 1 and 2, the blades 18-30 are secured to the second end portion 42 of the shaft 14 to rotate with the shaft 14. In the illustrated construction, the first and second blades 18, 22 are integrally formed or machined as a single piece with the shaft 14, and the third and fourth blades 26, 30 are integrally formed or machined as a single piece with each other. The third and fourth blades 26, 30 are then coupled (e.g., welded) to the first and second blades 18, 22. In some constructions, a slot (not shown) may be formed between the first and second blades 18, 22 to receive a portion of the third and fourth blades 26, 30. Additionally or alternatively, a second slot (not shown) may be formed between the third and fourth blades 26, 30 to receive a portion of the first and second blades 18, 22. In other constructions, the third and fourth blades 26, 30 may also be integrally formed or machined as a single piece with the shaft 14 and the first and second blades 18, 22. In still other constructions, each of the blades 18-30 may be formed independently and then coupled to the shaft 14.

The illustrated blades 18-30 are generally planar blades that extend radially outward from the longitudinal axis 46. Each blade 18-30 includes a front face 50, 54, 58, 62, a rear face 66, 70, 74, 78 opposite the front face 50-62, an outer edge 82, 86, 90, 94 defined by the front and rear faces 50-78 and extending generally parallel to the longitudinal axis 46, and a cutting edge 98, 102, 106, 110 extending radially from the longitudinal axis 46 toward the outer edge 82-94. Each cutting edge 98-110 is defined on an end of the corresponding blade 18-30 by the front face 50-62. The cutting edges 98-110 are generally sharpened to facilitate cutting and boring a hole in a work piece, while the outer edges 82-94 help smooth an inner surface of the bore as the drill bit 10 passes through and rotates within the work piece.

As shown in FIG. 3, the cutting edges 98-110 extend generally perpendicularly from the longitudinal axis 46. In other constructions, one or more of the cutting edges 98-110 may extend at an oblique angle relative to the longitudinal axis 46. For example, the cutting edges 98-110 may be oriented relative to the axis 46 such that an outermost end 114, 118, 122, 126 of each cutting edge 18-30 is positioned axially further from the first end portion 38 than a central, or inner, end 130, 134, 138, 142, or the cutting edges 98-110 may be oriented relative to the axis 46 such that the outermost end 114-126 of each cutting edge 18-30 is positioned axially closer to the first end portion 38 than the central end 130-142. In further constructions, each of the cutting edges 98-110 may be oriented at a different angle relative to the axis 46. For example, the first and second cutting edges 98, 102 may extend generally perpendicularly from the axis 46, while the third and fourth cutting edges 106, 110 may extend at oblique angles relative to the axis 46, or vice versa. In still other constructions, one or more of the cutting edges 98-110 may be curved.

As shown in FIGS. 2 and 3, the first and second blades 18, 22 are generally longer along the axis 46 than the third and fourth blades 26, 30. In the illustrated construction, an end 146 of the third blade 26 opposite the third cutting edge 106 is axially spaced from the second end portion 42 and from corresponding ends 150, 154 of the first and second blades 18, 22. Although not shown, it should be readily apparent that an end of the fourth blade 30 opposite the fourth cutting edge 10 is spaced approximately the same distance from the second end portion 42 as the end 146 of the third blade 26. In other constructions, all of the blades 18-30 may be generally the same length.

The pilot tip 34 is coupled to the third blade 26 and the fourth blade 30 and extends axially from the central ends 138, 142 of the cutting edges 106, 110 generally along the longitudinal axis 46. The pilot tip 34 helps properly locate and align the drill bit 10 on a work piece to begin cutting the work piece with the drill bit 10. The illustrated pilot tip 34 defines two cutting edges 158, 162 that extend from an apex 166 of the pilot tip 34 to the third and fourth cutting edges 106, 110 to smoothly transition into the cutting edges 106, 110. In the illustrated construction, the pilot tip 34 is a generally triangle-shaped planar tip that is integrally formed or machined with the third and fourth blades 26, 30. In other constructions, the pilot tip 34 may be generally conically-shaped and/or may be removably or permanently coupled to the blades 26, 30. Additionally or alternatively, the pilot tip 34 may include threads such that the drill bit 10 is a self-feed bit.

As shown in FIGS. 2 and 4, a chip removal flute 170, 174, 178, 182 is formed in the front face 50-62 of each blade 18-30. The chip removal flutes 170-182 are formed adjacent to the corresponding cutting edges 98-110 and are in communication with the outer edges 82-94 of the blades 18-30. The chip removal flutes 170-182 facilitate expulsion of sawdust and other cutting chips away from the cutting edges 98-110 as the drill bit 10 rotates to cut a hole in a work piece. Each blade 18-30 includes a beveled surface 186, 190, 194, 198 to smoothly transition from the front face 50-62 of the blade 18-30 to the chip removal flute 170-182. In other constructions, the blades 18-30 may include curved surfaces or more abrupt transitions between the front faces 50-62 and the flutes 170-182.

In the illustrated construction, a secondary chip removal flute 202, 206 is also formed on each face of the pilot tip 34. The secondary flutes 202, 206 extend along the cutting edges 158, 162 of the pilot tip 34 and are in communication with the chip removal flutes 178, 182 of the third and fourth blades 26, 30. The third and fourth flutes 178, 182 and the secondary flutes 202, 206 form single continuous flutes extending from the apex 166 of the pilot tip 34 to the outer edges 90, 94 of the blades 26, 30. In some constructions, one or more of the chip removal flutes 170-182, 202, 206 may be omitted.

The illustrated drill bit 10 also includes a cutting spur 210, 214, 218, 222 coupled to each blade 18-30. The cutting spurs 210-222 are positioned at intersections of the cutting edges 98-110 and the outer edges 82-94 of the blades 18-30 and extend axially from the outermost ends 114-126 of the cutting edges 98-110. The cutting spurs 210-222 are (aside from the pilot tip 34) the first portions of the drill bit 10 that contact a work piece. When the drill bit 10 is rotated, the cutting spurs 210-222 help score an outer circumference of the hole being cut in the work piece, thereby reducing chipping, cracking, and splintering of the work piece. In the illustrated construction, the cutting spurs 210-222 are integrally formed or machined as a single piece with the blades 18-30. In other constructions, the cutting spurs 210-222 may be permanently or removably coupled to the blades 18-30. In some constructions, one or more of the cutting spurs 210-222 may be omitted. For example, in one construction, only the first and second blades 18, 22 may include cutting spurs 210, 214; in another construction, only one of the blades 18-30 may include a cutting spur 210-222; and in yet another construction, none of the blades 18-30 may include a cutting spur 210-222.

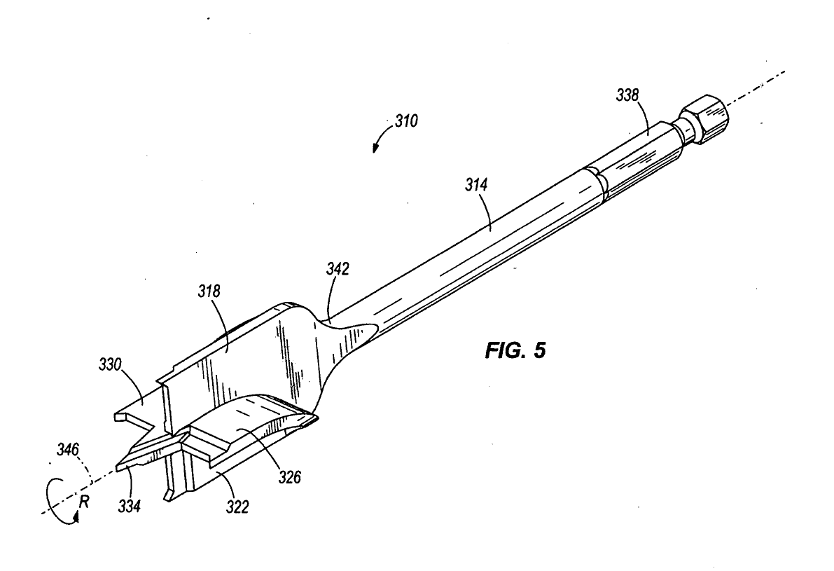

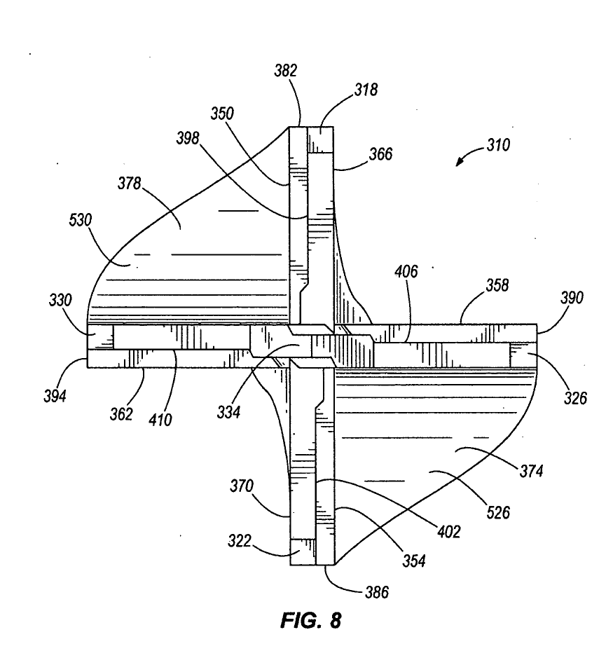

FIGS. 5-8 illustrate a drill bit 310 according to another embodiment of the invention. The illustrated drill bit 310 is similar to the drill bit 10 discussed above with reference to FIGS. 1-4 and like parts have been given the same reference numbers plus 300. Reference is hereby made to the description of the drill bit 10 above for description of features and elements, as well as alternatives to the features and elements, of the drill bit 310 not specifically discussed below.

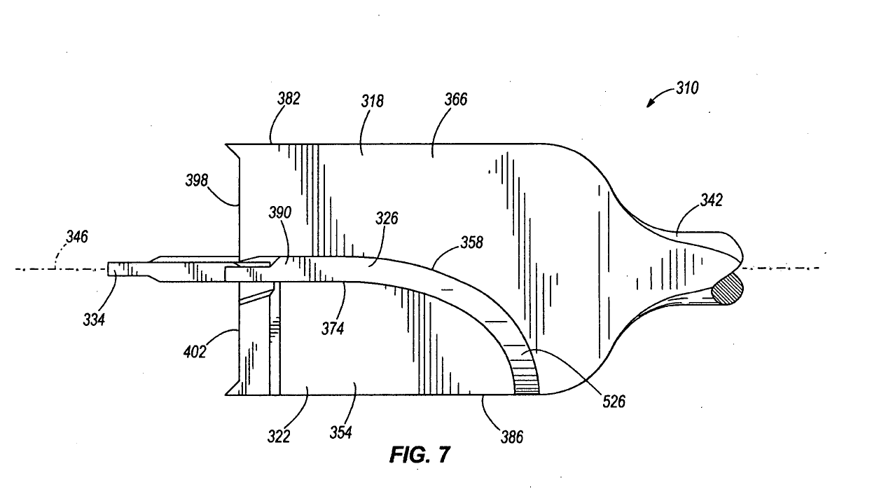

The illustrated drill bit 310 includes an elongated shaft 314, a plurality of blades 31 8, 322, 326, 330 to cut a hole in a work piece, and a pilot tip 334 to facilitate proper alignment of the drill bit 310 with the work piece. The shaft 314 includes a first end portion 338 that is connectable to a power tool, a second end portion 342 substantially opposite the first end portion 338 to support the blades 318, and a longitudinal axis 346 (FIGS. 5 and 7) extending through the first and second end portions 338, 342.

Similar to the drill bit 10 discussed above, the illustrated drill bit 10 includes four blades 318-330 coupled to the second end portion 342 of the shaft 314, but may alternatively include fewer or more blades 318-330. The blades 318-330 are equally spaced apart about the longitudinal axis 346 such that each of the blades 318-330 is spaced approximately 90° apart from the two adjacent blades 318-330. Each blade 318-330 includes a front face 350, 354, 358, 362, a rear face 366, 370, 374, 378 opposite the front face 350-362, an outer edge 382, 386, 390, 394 defined by the front and rear faces 350-378 and extending generally parallel to the longitudinal axis 346, and a cutting edge 398, 402, 406, 410 extending radially from the longitudinal axis 346 to the outer edge 382-394.

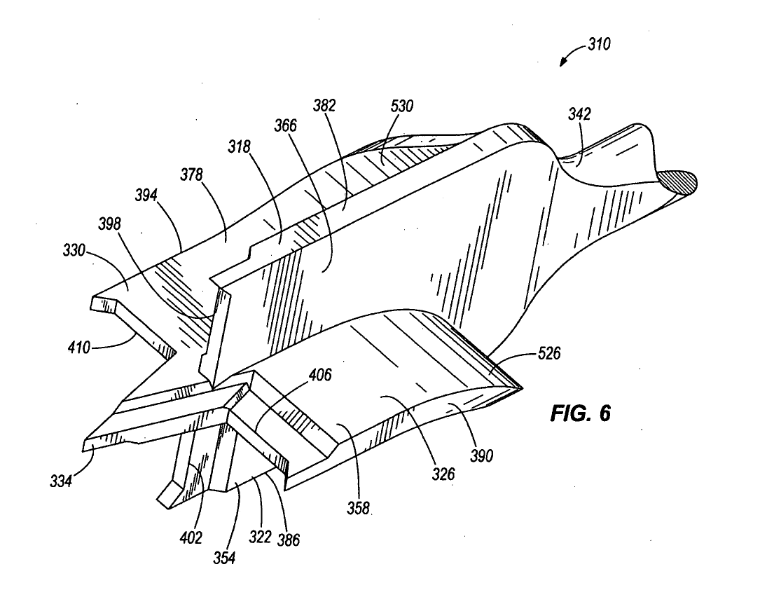

In the illustrated construction, the first and second blades 318, 322 are generally planar and the third and fourth blades 326, 330 are curved. As shown in FIGS. 6-8, a portion 526 of the third blade 322 opposite the cutting edge 406 gradually curves toward the outer edge 386 of the second blade 322, and a portion 530 of the fourth blade 330 opposite the cutting edge 410 gradually curves toward the outer edge 382 of the first blade 318. The third and fourth blades 326, 330 thereby curve in a direction opposite the direction of rotation R of the drill bit 310. Such an arrangement facilitates chip removal during operation of the drill bit 310 by directing sawdust or other chips generally along curved faces (i.e., the front faces 358, 362 of the third and fourth blades 326, 330 shown in FIGS. 5-8) rather than only along planar faces (i.e., the front faces 58, 62 of the third and fourth blades 26, 30 shown in FIGS. 1-4). In some constructions, the first and second blades 318, 322 may also be curved.

The illustrated drill bits 10, 310 include more blades than typical spade bits to create cleaner (e.g., smoother) holes in work pieces. That is, the additional blades reduce the amount of chipping, cracking, or splintering of a work piece as the drill bits 10, 310 bore a hole through the work piece. Furthermore, the additional blades increase the overall strength of the drill bits 10, 310 by distributing the cutting force over three or more blades, allowing the drill bits 10, 310 to operate at generally higher rotational speeds and increasing the usable life of the drill bits 10, 310.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A drill bit comprising:
a shaft having a first end portion connectable to a power tool and a second end portion substantially opposite the first end portion, the shaft defining a longitudinal axis extending through the first and second end portions;
a first generally planar blade coupled to the second end portion of the shaft and defining a first cutting edge extending generally perpendicularly from the longitudinal axis;
a second generally planar blade coupled to the second end portion of the shaft and defining a second cutting edge extending generally perpendicularly from the longitudinal axis, the second blade being spaced apart from the first blade about the longitudinal axis;
a third blade coupled to the second end portion of the shaft and defining a third cutting edge extending generally perpendicularly from the longitudinal axis, the third blade being spaced apart from the first blade and the second blade about the longitudinal axis; and
a pilot tip extending from at least one of the first, second, and third cutting edges generally along the longitudinal axis.

2. The drill bit of claim 1, wherein the third blade is equally spaced apart from the first blade and the second blade.

3. The drill bit of claim 1, further comprising a chip removal flute formed in the third blade and the pilot tip adjacent to the third cutting edge, wherein the chip removal flute extends to an outer edge of the third blade.

4. The drill bit of claim 1, further comprising a fourth blade coupled to the second end portion of the shaft and defining a fourth cutting edge extending generally perpendicularly from the longitudinal axis, wherein the fourth blade is spaced apart from the first blade, the second blade, and the third blade about the longitudinal axis.

5. The drill bit of claim 4, wherein the pilot tip extends from the third cutting edge and the fourth cutting edge generally along the longitudinal axis.

6. The drill bit of claim 4, wherein the first, second, third, and fourth blades are symmetrically spaced apart about the longitudinal axis.

7. The drill bit of claim 1, further comprising:
a first cutting spur coupled to an end of the first blade substantially opposite the longitudinal axis, the first cutting spur extending axially from the first cutting edge,
a second cutting spur coupled to an end of the second blade substantially opposite the longitudinal axis, the second cutting spur extending axially from the second cutting edge, and
a third cutting spur coupled to an end of the third blade substantially opposite the longitudinal axis, the third cutting spur extending axially from the third cutting edge.

8. The drill bit of claim 1, wherein the third blade is a generally planar blade.

9. The drill bit of claim 1, wherein a portion of the third blade opposite the third cutting edge curves toward an outer edge of the second blade.

10. A drill bit comprising:
a shaft having a first end portion connectable to a power tool and a second end portion opposite the first end portion, the shaft defining a longitudinal axis extending through the first and second end portions;
a first generally planar blade coupled to the second end portion of the shaft and defining a first cutting edge extending radially from the longitudinal axis;
a second generally planar blade coupled to the second end portion of the shaft and defining a second cutting edge extending radially from the longitudinal axis, the second blade being spaced apart from the first blade about the longitudinal axis;
a third blade coupled to the second end portion of the shaft and defining a third cutting edge extending radially from the longitudinal axis, the third blade being spaced apart from the first blade and the second blade about the longitudinal axis; and
a cutting spur coupled to an end of the third blade substantially opposite the longitudinal axis, the cutting spur extending axially from the third cutting edge.

11. The drill bit of claim 10, wherein the third blade is equally spaced apart from the first blade and the second blade.

12. The drill bit of claim 10, further comprising:
a second cutting spur coupled to an end of the first blade substantially opposite the longitudinal axis, the second cutting spur extending axially from the first cutting edge, and
a third cutting spur coupled to an end of the second blade substantially opposite the longitudinal axis, the third cutting spur extending axially from the second cutting edge.

13. The drill bit of claim 10, further comprising a fourth blade coupled to the second end portion of the shaft and defining a fourth cutting edge extending radially from the longitudinal axis, wherein the fourth blade is spaced apart from the first blade, the second blade, and the third blade about the longitudinal axis.

14. The drill bit of claim 13, wherein the first, second, third, and fourth blades are symmetrically spaced apart about the longitudinal axis.

15. The drill bit of claim 10, further comprising a pilot tip extending from at least one of the first, second, and third cutting edges generally along the longitudinal axis.

16. The drill bit of claim 10, wherein the first cutting edge, the second cutting edge, and the third cutting edge extend generally perpendicularly from the longitudinal axis.

17. The drill bit of claim 10, wherein the third blade is a generally planar blade.

18. The drill bit of claim 10, wherein a portion of the third blade opposite the third cutting edge curves toward an outer edge of the second blade.

19. A drill bit comprising:
a shaft having a first end portion connectable to a power tool and a second end portion substantially opposite the first end portion, the shaft defining a longitudinal axis extending through the first and second end portions;
a first generally planar blade coupled to the second end portion of the shaft and defining a first cutting edge extending generally perpendicularly from the longitudinal axis;
a second generally planar blade coupled to the second end portion of the shaft and defining a second cutting edge extending generally perpendicularly from the longitudinal axis, the second blade being spaced apart from the first blade by approximately 180° about the longitudinal axis;
a third blade coupled to the second end portion of the shaft and defining a third cutting edge extending generally perpendicularly from the longitudinal axis, the third blade being spaced apart from the first blade and the second blade about the longitudinal axis;
a fourth blade coupled to the second end portion of the shaft and defining a fourth cutting edge extending generally perpendicularly from the longitudinal axis, the fourth blade being spaced apart from the third blade by approximately 180° about the longitudinal axis; and
a pilot tip extending from the third blade and the fourth blade generally along the longitudinal axis.

20. The drill bit of claim 19, wherein the first, second, third, and fourth blades are symmetrically spaced apart about the longitudinal axis.

21. The drill bit of claim 19, further comprising:
a first cutting spur coupled to an end of the first blade substantially opposite the longitudinal axis, the first cutting spur extending axially from the first cutting edge,
a second cutting spur coupled to an end of the second blade substantially opposite the longitudinal axis, the second cutting spur extending axially from the second cutting edge,
a third cutting spur coupled to an end of the third blade substantially opposite the longitudinal axis, the third cutting spur extending axially from the third cutting edge, and
a fourth cutting spur coupled to an end of the fourth blade substantially opposite the longitudinal axis, the fourth cutting spur extending axially from the fourth cutting edge.

22. The drill bit of claim 19, further comprising:
a first chip removal flute formed in the third blade and the pilot tip adjacent to the third cutting edge, the first chip removal flute extending to an outer edge of the third blade, and
a second chip removal flute formed in the fourth blade and the pilot tip adjacent to the fourth cutting edge, the second chip removal flute extending to an outer edge of the fourth blade.

23. The drill bit of claim 19, wherein the third blade and the fourth blade are generally planar blades.

24. The drill bit of claim 19, wherein a portion of the third blade opposite the third cutting edge curves toward an outer edge of the second blade, and wherein a portion of the fourth blade opposite the fourth cutting edge curves toward an outer edge of the first blade.
